(19) United States
(12) Patent Application Publication
(10) Pub. No.: US 2026/0213432 A1
(43) Pub. Date: Jul. 23, 2026

(54) RING TERMINAL WITH INTEGRATED ANTI-ROTATIONAL THIRD HAND MECHANISM

(71) Applicant: GM GLOBAL TECHNOLOGY OPERATIONS LLC, Detroit, MI (US)

(72) Inventors: Frank Ryan Kuehnl, Pinckney, MI (US); Casey West Teodecki, Brighton, MI (US); Edward Liu, Canton, MI (US); Shyama Maria Jose, Troy, MI (US); Venerando Salas Jayoma, Windsor, CA (US); Tom T. Srbinovski, Shelby Township, MI (US)

(21) Appl. No.: 19/032,941

(22) Filed: Jan. 21, 2025

(51) Int. Cl. H01R 4/30; H01R 4/34; H01R 43/26

(52) U.S. Cl. CPC H01R 4/305; H01R 4/34; H01R 43/26

(57) ABSTRACT

A vehicle includes a body defining a passenger compartment. The body includes a substrate having an attachment opening and an alignment feature. A wiring harness including a plurality of electrical conductors is supported on the substrate. A ring terminal system connects one of the plurality of electrical conductors to the substrate. The ring terminal system includes a ring terminal having a ring terminal body including a conductor end and a connector portion. The conductor end includes a surface electrically connected to the one of the plurality of electrical conductors. The connector portion includes a first opening and a second opening. The first opening is configured to receive a temporary fastener that passes into the alignment feature to align the second opening with the attachment opening on the substrate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to ring terminals and, more particularly, to a ring terminal having an integrated third hand mechanism that facilitates attachment of a conductor of a wiring harness to another component.

Vehicles include multiple wiring harnesses that carry electrical current to various vehicle systems. Most wiring harnesses include a ground conductor. On a vehicle, the ground conductor is connected to a metal component such as a body part, a chassis part, or the like. The ground conductor is typically terminated with a ring terminal including an opening. The ring terminal is electrically connected to the ground conductor and is designed to receive a fastener through the opening.

### SUMMARY

A vehicle, in accordance with the present disclosure, includes a body defining a passenger compartment. The body includes a substrate having an attachment opening and an alignment feature. A wiring harness including a plurality of electrical conductors is supported on the substrate. A ring terminal system connects one of the plurality of electrical conductors to the substrate. The ring terminal system includes a ring terminal having a ring terminal body including a conductor end and a connector portion. The conductor end includes a surface electrically connected to the one of the plurality of electrical conductors. The connector portion includes a first opening and a second opening. The first opening is configured to receive a temporary fastener that passes into the alignment feature to align the second opening with the attachment opening on the substrate.

In other features, the temporary fastener comprises a push pin extending pass through the first opening into the alignment feature formed in the substrate.

In other features, the push pin is a fir tree clip.

In other features, the first opening is a slotted opening.

In other features, the second opening is a substantially circular opening.

In other features, the ring terminal body is formed from a first material and coated with a second material.

In other features, the first material is stamped metal, and the second material is copper.

A ring terminal system for connecting a conductor to a substrate, in accordance with the present disclosure, includes a ring terminal having a ring terminal body including a conductor end and a connector portion. The conductor end includes a surface configured to electrically connect with a conductor. The connector portion includes a first opening and a second opening. The first opening is configured to receive a temporary fastener to align the second opening with an attachment opening on the substrate.

In other features, a push pin is configured to pass through the first opening into an alignment feature formed in the substrate.

In other features, the push pin is a fir tree clip.

In other features, the first opening is a slotted opening.

In other features, the second opening is a substantially circular opening.

In other features, the ring terminal body is formed from a first material and coated with a second material.

In other features, the first material is stamped metal, and the second material is copper.

A method of securing a conductor to a substrate in a vehicle in accordance with the present disclosure includes positioning a ring terminal against the substrate, aligning a first opening in the ring terminal with an alignment feature formed in the substrate, installing a temporary fastener through the first opening into the alignment feature, and aligning a second opening in the ring terminal with an attachment opening formed in the substrate by aligning the first opening with the alignment feature.

In other features, installing the temporary fastener through the first opening includes installing a push pin into the first opening.

In other features, installing the push pin into the alignment feature includes installing a fir tree clip through the first opening into the alignment feature.

In other features, the ring terminal is secured to the substrate by passing a fastener through the second opening into the attachment opening.

In other features, passing the fastener through the second opening includes passing a threaded fastener through a substantially circular opening.

In other features, securing the ring terminal to the substrate includes engaging the threaded fastener with a plurality of threads in the attachment opening.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a front left perspective view of a vehicle including a ring terminal having an integrated anti-rotating third hand mechanism, in accordance with the present disclosure;

FIG. 2 is a perspective view of the ring terminal, in accordance with the present disclosure; and

FIG. 3 is a disassembled view of the ring terminal of FIG. 2, in accordance with the present disclosure.

In the drawings, reference numbers may be reused to identify similar and/or identical elements.

### DETAILED DESCRIPTION

While ring terminals are described below in the context of connecting a harness to a component of a vehicle, the ring terminals can be used to provide a secure electrical connections in other mobile or stationary applications.

Connecting the ground conductor and, more specifically, the ring terminal to the vehicle can be tricky. Securing a fastener (through the ring terminal to connect the ground conductor to the vehicle component) often requires what is colloquially deemed a “third hand”. The need for the “third hand” is greater during production. The ring terminal must be aligned with an opening on the vehicle component, the fastener inserted, and a tool manipulated to secure the fastener. Often times, the wire harness is stiff. Thus, maintaining alignment between the ring terminal and the opening on the vehicle component while the fastener is retrieved while also holding a tool can be challenging. Accordingly, a system for temporarily securing the ring terminal to the vehicle while also maintaining alignment between the opening in the ring terminal and the opening in the vehicle component would be welcomed by the industry.

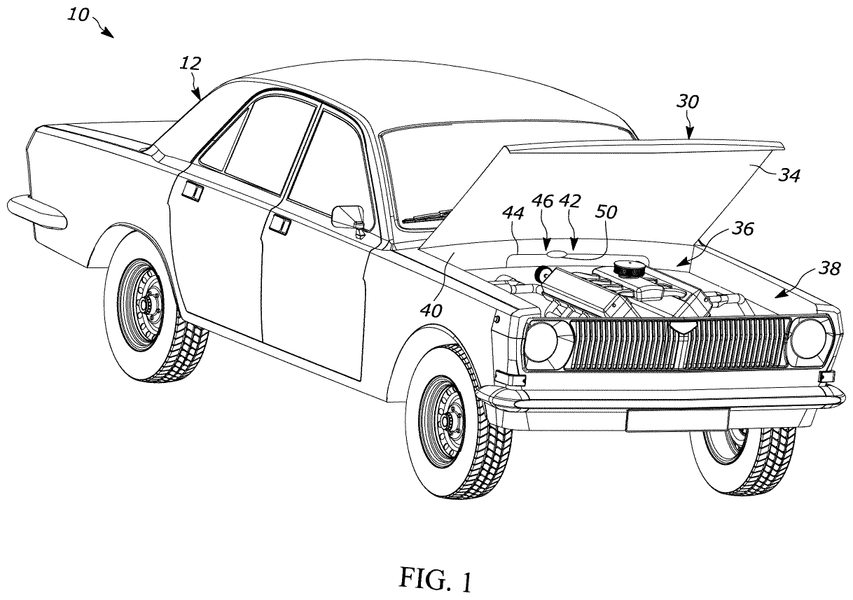

A vehicle, in accordance with the present disclosure, is indicated generally at 10 in FIG. 1. Vehicle 10 includes a body 12 having a hatch 30 shown in the form of a hood 34. Hatch 34 may also serve to cover a frunk depending upon vehicle model. A vehicle surface 36 is exposed when hood 34 is open. Vehicle surface 36 may define an engine compartment 38 having a substrate 40. Substrate 40 may define a firewall (not separately labeled). Substrate 40 is formed from an electrically conductive material, such as metal, and may be grounded. At this point, it should be understood that while vehicle 10 is shown to include an internal combustion engine, other power systems, including electric and hybrid electric may also be employed.

A wiring harness 42 is supported on substrate 40. Wiring harness 42 includes a plurality of conductors 44 one of which includes a ring terminal system 46. Ring terminal system 46 includes a ring terminal 50 that is electrically connected to substrate 40 to provide an electrical ground to wiring harness 42.

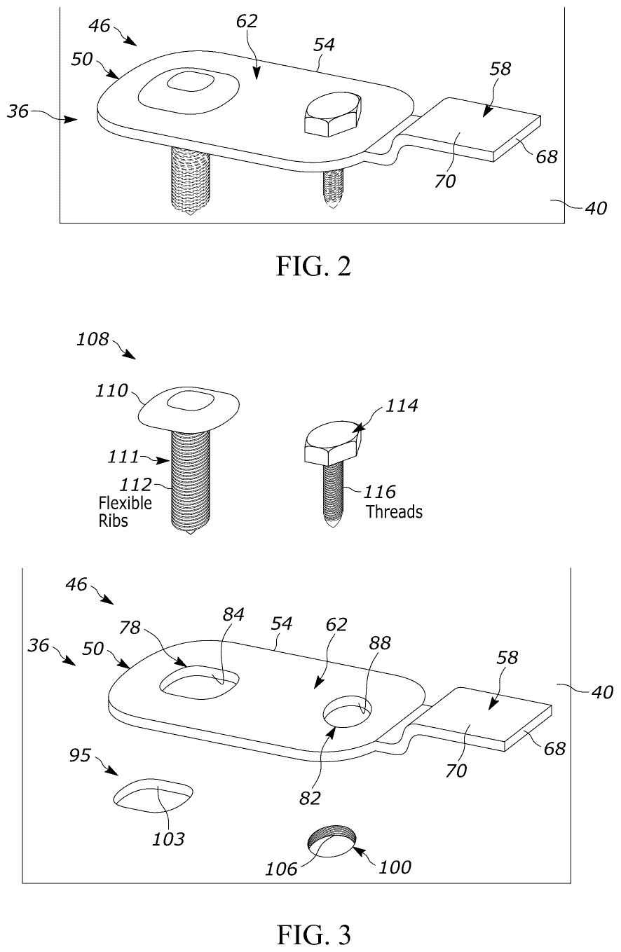

Referring to FIGS. 2 and 3, ring terminal 50 includes a body 54 that is formed from an electrically conductive material such as, for example, stamped metal. The stamped metal may be clad in a copper alloy. Of course, it should be understood that body 54 could be formed from or clad in a variety of materials including alloys of gold, silver, and tin, or other electrically conductive materials. Body 54 includes a conductor end 58 and a connector portion 62. Conductor end 58 includes a tab 68 having a surface 70 that may be electrically connected to one of the plurality of conductors 44 through for example, a mechanical bond or crimp or a chemical bond such as a solder joint. Connector portion 62 includes a first opening 78 and a second opening 82 (FIG. 3). First opening 78 is shown in the form of a slotted opening 84 and second opening 82 is shown in the form of a substantially circular opening 88.

Substrate 40 includes an alignment feature 95 and an attachment opening 100. Alignment feature 95 takes the form of an elongated opening 103 while attachment opening 100 takes the form of a substantially circular threaded opening 106. With this arrangement, ring terminal 50 may be positioned on substrate 40 with slotted opening 84 being in alignment with elongated opening 103. A technician may then insert a push pin 108 that forms a temporary fastener 110 through slotted opening 84 into elongated opening 103.

Push pin 108 takes the form of a fir tree clip 111 including a plurality flexible ribs 112 that engage with substrate 40 to temporarily hold ring terminal 50 in position. At this point, the technician may release ring terminal 50. At this point, with two hands being available, the technician may insert a fastener 114 including a plurality of threads 116 through circular opening 88 into threaded opening 106. Once inserted, the technician may use a tool, such as a ratchet, to tighten fastener 114 and secure ring terminal 50 to substrate 40. The shape of slotted opening 84 and the use of push pin 108 allows technicians to temporarily affix ring terminal 50 to substrate 40 in a desired alignment and then have two hands free to ensure a proper grounded connection.

The terms “about” and “substantially” are intended to include the degree of error associated with measurement of the particular quantity based upon the equipment available at the time of filing the application. For example, “about” and “substantially” can include a range of ±8% of a given value.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A vehicle comprising:
a body defining a passenger compartment, the body including a substrate having an attachment opening and an alignment feature;
a wiring harness including a plurality of electrical conductors is supported on the substrate; and
a ring terminal system connecting one of the plurality of electrical conductors to the substrate, the ring terminal system comprising:
a ring terminal having a body including a conductor end and a connector portion, the conductor end including a surface electrically connected to the one of the plurality of electrical conductors, wherein the connector portion includes a first opening and a second opening, the first opening being configured to receive a temporary fastener that passes into the alignment feature to align the second opening with the attachment opening on the substrate.

2. The vehicle according to claim 1, wherein the temporary fastener comprises a push pin extending pass through the first opening into the alignment feature formed in the substrate.

3. The vehicle according to claim 2, wherein the push pin is a fir tree clip.

4. The vehicle according to claim 2, wherein the first opening is a slotted opening.

5. The vehicle according to claim 1, wherein the second opening is a substantially circular opening.

6. The vehicle according to claim 1, wherein the body is formed from a first material and coated with a second material.

7. The vehicle according to claim 6, wherein the first material is stamped metal, and the second material is copper.

8. A ring terminal system for connecting a conductor to a substrate, the ring terminal system comprising:
a ring terminal having a body including a conductor end and a connector portion, the conductor end including a surface configured to electrically connect with a conductor, wherein the connector portion includes a first opening and a second opening, the first opening being configured to receive a temporary fastener to align the second opening with an attachment opening on the substrate.

9. The ring terminal system according to claim 8, further comprising a push pin configured to pass through the first opening into an alignment feature formed in the substrate.

10. The ring terminal system according to claim 9, wherein the push pin is a fir tree clip.

11. The ring terminal system according to claim 9, wherein the first opening is a slotted opening.

12. The ring terminal system according to claim 8, wherein the second opening is a substantially circular opening.

13. The ring terminal system according to claim 8, wherein the body is formed from a first material and coated with a second material.

14. The ring terminal system according to claim 13, wherein the first material is stamped metal, and the second material is copper.

15. A method of securing a conductor to a substrate in a vehicle, the method comprising:
positioning a ring terminal against the substrate;
aligning a first opening in the ring terminal with an alignment feature formed in the substrate;
installing a temporary fastener through the first opening into the alignment feature; and
aligning a second opening in the ring terminal with an attachment opening formed in the substrate by aligning the first opening with the alignment feature.

16. The method of claim 15, wherein installing the temporary fastener through the first opening includes installing a push pin into the first opening.

17. The method of claim 16, wherein installing the push pin into the alignment feature includes installing a fir tree clip through the first opening into the alignment feature.

18. The method of claim 15, further comprising securing the ring terminal to the substrate by passing a fastener through the second opening into the attachment feature.

19. The method of claim 18, wherein passing the fastener through the second opening includes passing a threaded fastener through a substantially circular opening.

20. The method of claim 19, wherein securing the ring terminal to the substrate includes engaging the threaded fastener with a plurality of threads in the attachment opening.
